(19) United States
(12) Patent Application Publication
(10) Pub. No.: US 2015/0320064 A1
(43) Pub. Date: Nov. 12, 2015

(54) Creamy Yogurt Base

(71) Applicants: Kristin Lee Lyle, Natoma, KS (US); Fadi Aramouni, Manhattan, KS (US)

(72) Inventors: Kristin Lee Lyle, Natoma, KS (US); Fadi Aramouni, Manhattan, KS (US)

(21) Appl. No.: 14/704,711

(22) Filed: May 5, 2015

Related U.S. Application Data
(60) Provisional application No. 61/990,474, filed on May 8, 2014.

(51) Int. Cl. A23C 9/152; A23L 1/30; A23C 9/154

(52) U.S. Cl. CPC A23C 9/152; A23C 9/154; A23L 1/3014; A23V 2002/00

(57) ABSTRACT

This creamy yogurt base provides a base with similar appearance, texture, and taste to cream cheese and sour cream products, but contains less calories, fat, and cholesterol while providing a similar mouth feel associated with consuming these full fat products. Additionally, this product can replace common fats used in cooking, baking, and frozen systems. This yogurt base is produced by combining a quantity of dairy liquid with food grade gum. Then, additional diary liquid is added and this mixture is heated for 10-90 minutes at a temperature between 85-250 degrees Fahrenheit. The product is then added to Greek style yogurt and cooled to 45 degrees Fahrenheit, or less, to form a creamy yogurt base. Additional ingredients can be added to the base to produce dips, spreads, fillings, gravies, dressings, and frostings providing a similar appearance, texture, and taste to products containing higher levels of calories, fat, and cholesterol.

### CROSS-REFERENCE TO RELATED APPLICATIONS

The present Non-Provisional application is related to, and claims the priority benefit of the U.S. Provisional Patent Application Ser. No. 61/990,474, filed May 8, 2014, the contents of which are hereby incorporated into the present disclosure in their entirety.

### STATEMENT REGARDING FEDERALLY SPONSORED RESEARCH OR DEVELOPMENT

### If Applicable

Not Applicable

### REFERENCE TO SEQUENCE LISTING, A TABLE, OR A COMPUTER PROGRAM LISTING COMPACT DISC APPENDIX

### If Applicable

Not Applicable

### BACKGROUND OF THE INVENTION

The purpose of this invention is to provide consumers with a low fat or fat-free yogurt based alternative, to similar products which possess higher amounts of calories, fat, and cholesterol, such as cream cheese and sour cream based dips and spreads, without having to sacrifice the pleasure and mouth feel experienced when consuming a full fat product. An additional appealing factor of a yogurt based dip or spread is that these dips and spread would have the possibility of containing probiotics since the yogurt base used is composed of 50-95% cultured Greek yogurt based on the weight of the final creamy yogurt base. Furthermore, the creamy yogurt base can be used to replace commonly used fats in cooking, baking, and frozen systems. Due to the increase in health and weight related problems such as obesity and type 2 diabetes which have been linked, in part, to diets that are high in fats and cholesterols, it is important to provide alternative food items that mimic products on the market that have high amounts of fat such as sour cream and cream cheese. This invention would provide consumers with a yogurt based nutritious and palatable product but provide much fewer calories, fat, and cholesterol per serving. In 2012 it was found that an estimated 34.9% of adults in the United States are obese and that over one third of children and adolescents in the United States were also considered to be overweight or obese¹. Cream cheese typically has a fat content between 35%-45%, and must contain at least 33% milkfat by weight of the finished product according to the Code of Federal Regulations (CFR), which is why the resulting product contains high levels of calories and fat per serving². Similarly, sour cream must contain at least 18% milkfat by weight of the finished product in accordance with the CFR³. The creamy yogurt base described in this patent ranges between 0%-6% fat and still provides the mouth feel and satisfaction of consuming a full fat product. This would provide consumers with a healthier alternative to high fat products that are a contributing factor to the rising levels of obesity.

One traditional approach to reducing calories, fat, and cholesterol in a finished cream cheese or sour cream based dip or spread has included mixing either cream cheese or sour cream with yogurt⁷. The yogurt reduces the overall calories, fat, and cholesterol while the cream cheese or sour cream contributes to the flavor and mouth feel of the product. An additional approach is to make a yogurt based dip or spread by using milk or cream which contains a higher milkfat content prior to fermentation. This produces a thicker product during the culturing of the yogurt, and the additional fat also increases the mouth feel of the finished product. Even though these two examples successfully reduce the overall calories, fat, and cholesterol levels of the finished product for a dip or spread, the finished product is still unable to provide the mouth feel of a full fat product, and since these methods utilize yogurt, there is an increased amount of syneresis and whey accumulation in the finished products which is negatively viewed by consumers. The current technology being described in this patent is capable of reducing the calories, fat, and cholesterol levels without sacrificing palatability and the finished product is capable of producing less than 1% syneresis of whey by weight after four weeks when stored at refrigerated temperatures ranging between 35-45 degrees Fahrenheit.

Additional patented approaches to producing yogurt dips and spreads which are similar to cream cheese and sour cream have also been documented. One method is to reduce the fat and moisture content of the milk prior to fermentation through separation and using a conventional vacuum to remove the moisture in amounts up to 75%⁶. The moisture removed contains sweet whey due to the fact that it is being removed prior to the fermentation; therefore it is less harmful to the environment when disposed of. Since this product is reducing the moisture content, it would yield a thicker finished yogurt. However, this approach would be unlikely to yield a product that would be heat stable in cooking and baking systems or be capable of replacing additional high fat products besides cream cheese or sour cream, unlike the invention described. Furthermore, the acid whey produced by traditional yogurt culturing techniques is now being utilized in medical treatments and research. This by-product of yogurt is no longer viewed as a waste, but it is a highly valuable commodity and is now considered to be a functional food used to promote muscle protein synthesis in the body⁴. Additional research is revealing properties of whey consumption to include enhancing the immune system, working as an antioxidant, containing properties that are antihypertensive, antitumor, hypolipidemic, antiviral, and antibacterial⁵.

A second method to produce a yogurt based dip and spread has been accomplished by fermenting milk to produce yogurt, mixing the yogurt with a brine solution composed of 3-12% salt and then centrifuging the yogurt and brine mixture to remove the majority of the whey contained in the yogurt⁸. This also would produce a thicker final product due to the removal of whey, however, since there is only an addition of a minute amount of gums, it is also unlikely that this product would be heat stable and would be able to be used in cooking and baking systems. Furthermore, the moisture removed from the product while centrifuging would contain a mixture of whey and brine solution that would need further separation in order to recover the whey to use as a salable byproduct.

### BRIEF SUMMARY OF THE INVENTION

One of the objectives of this innovative product is to provide a healthy alternative to real, imitation, and reduced fat, cream cheese and sour cream based spreads, dips, fillings (such as but not limited to dessert fillings or deviled eggs), dressings (such as but not limited to salad dressings, pasta and potato salad dressings, and mayonnaise based dressings), and desserts by providing a yogurt based spread, dip, filling, dressing or dessert with substantially less calories, fat, and cholesterol. This yogurt based product would provide the prior listed health benefits without sacrificing the palatability and pleasure of consuming a full fat product. An additional objective of this multifunctional product is to replace real and imitation butter, cream cheese, cream, oil, sour cream, and additional fats in cooking, baking, and frozen systems to provide lower calorie baked goods and desserts, such as but not limited to, cookies, cakes, pies, creams, brownies, pancakes, frozen yogurt, rolls, breads, muffins, and cheesecakes. By replacing products containing high amounts of fats and calories traditionally used in cooking and baking systems with this yogurt based product, it allows baked goods to easily be produced with very few alterations to the original “full fat” recipes. When using the creamy yogurt base in cooking and baking, consumers would receive the health benefits of reducing overall calories in cooked and baked goods and it is possible to reduce or eliminate fat calories and cholesterol that would otherwise be contributed by these alternative full fat ingredients. The final products produced using the yogurt base also yield similar or superior appearance, texture, and taste to their full fat counterparts while providing substantially less calories, fat, and cholesterol.

The present invention as described in this patent provides a process to create a product similar to cream cheese and sour cream in appearance, texture, and taste, that can be flavored and consumed as is, or used in desserts, cooking, baking, and frozen systems to replace real and imitation butter, cream cheese, oil, sour cream, cream, and other fats used in baking. The use of this unique product provides foods, snacks, baked goods, and desserts which possess reduced amounts of calories, fat, and cholesterol in comparison to producing these products with real and imitation butter, cream cheese, oil, sour cream, and other fats used in cooking and baking. This innovative product is produced by combining a dairy liquid consisting of cream, milk and/or reconstituted milk with a milkfat content of 3.5% or less, or a combination thereof, with a food grade gum or mix of gums. The food grade gum or gum mixture can include one or more of the following: guar gum, carrageenan, locust bean gum, and Xanthan gum. After the dairy liquid and gum have been combined, additional diary liquid is added and the resulting mixture is heated for 10-90 minutes at a temperature between 85-250 degrees Fahrenheit. This dairy liquid and gum mixture is then added to a traditional Greek style yogurt which can either be purchased in bulk, or manufactured by culturing milk to produce yogurt and then removing excess whey from the yogurt by straining, centrifuging, or other methods acceptable for producing a Greek style yogurt or a yogurt with reduced moisture content. This product is then cooled to 45 degrees Fahrenheit or less. The resulting product is a creamy yogurt base. At this point or any point prior in the process of making the creamy yogurt base, the following ingredients including but not limited to natural and/or artificial flavor(s), color(s), seasoning(s), regular or dehydrated fruit and/or vegetable pieces, sweetener(s), emulsifier(s), thickening agent(s), starches, stabilizer(s), gums, powdered or hydrated milks and/or cream(s), antioxidant(s), probiotics(s), fiber, protein, oil(s), and preservative(s) may be added. The plain or flavored creamy yogurt base can then be consumed as is, or used as an ingredient in desserts, cooking, baking, and frozen systems to produce products that have similar appearance, texture and taste to products produced using full fat ingredients. The creamy yogurt base described in the present invention is free from chalkiness and graininess which are characteristics which typically accompany the use of gums at these levels. Based on this unexpected result of the combination of these known ingredients, the product being described falls into the general category of “composition of matter.”

### BRIEF DESCRIPTION OF THE SEVERAL VIEWS OF THE DRAWING

Not Applicable

### DETAILED DESCRIPTION OF THE INVENTION

Previous to the present invention, yogurt has been added to ingredients containing higher amounts of calories, fat, and cholesterol, such as cream cheese or sour cream, in efforts to reduce these levels in the finished product. Additionally, the process of producing yogurt has been manipulated to yield a thicker yogurt with lower moisture content in order to mimic cream cheese and sour cream in appearance, texture, and taste. These products are reported to be successful in reduction of calories, fat, and cholesterol while yielding a product that has an improved mouth feel due to fat content or increased thickness. However, the present invention is a Greek yogurt base combined with a dairy liquid and gum mixture to produce a creamy yogurt base that is low fat or fat free, and provides less calories, fat, and cholesterol per serving while delivering similar appearance, texture, and taste to cream cheese or sour cream. It is also capable of withstanding cooking, baking, and frozen temperatures, enabling it to be used in cooking, baking, and frozen systems.

All of the following percentages are figured by weight of the final creamy yogurt base. This innovative product is made by combining approximately 10-20% diary liquid consisting of cream, milk, and/or reconstituted milk with a milkfat content at or below 3.5%, or a combination thereof, ideally skim milk or fat free milk is used at 15-18%, with a food grade gum or gum mixture at a range of 0.2-3.0%, with the typical formulation containing between 0.8-1.3%, until gums are partially hydrated and mixture becomes thick. The food grade gum or gum mixture can include one or more of the following: guar gum, carrageenan, locust bean gum, and Xanthan gum. One embodiment of this invention utilizes a mixture of guar gum and locust bean gum at 0.5% and 0.4% respectively. Next, an additional amount of diary liquid consisting of cream, milk, and/or reconstituted milk with a milkfat content at or below 3.5%, or a combination thereof, is then added to the existing diary liquid and gum mixture, ideally skim milk or fat free milk is used at 8-11%. This final dairy liquid and gum mixture is then heated for 10-90 minutes at a temperature between 85-250 degrees Fahrenheit. Time and temperature may vary depending on specific formulations so that the time and temperature combination will be sufficient to allow the gum or gum mixture to hydrate. Mixing and heating the ingredients in this order allow the gums to hydrate and create a creamy texture that resembles full fat products opposed to a grainy, gritty, or chalky texture that typically results from using gums. After the dairy liquid and gum mixture has been sufficiently heated, it is added to a Greek style yogurt either obtained in bulk or manufactured by culturing milk using lactic acid-producing bacteria Lactobacillus bulgaricus, Streptococcus thermophilus, and additional lactic acid-producing bacteria strains if desired. The resulting yogurt will then be strained, centrifuged, or undergo any other method acceptable for removing excess whey to produce a Greek yogurt or a yogurt with reduced moisture content. The Greek yogurt is added at 50-95% depending on the final desired thickness and consistency of the product. Typical formulation ranges between 70-85%. If a lighter, airier texture is desired then the creamy yogurt base can be whipped. As previously mentioned, the finished product is capable of producing less than 1% syneresis of whey by weight after four weeks when stored at refrigerated temperatures ranging between 35-45 degrees Fahrenheit due to the amount of gums used. As the product is stored, whey continues to be released by the yogurt, and the gums continue to absorb the excess whey produced, therefore reducing visible syneresis and increasing the creamy texture of the creamy yogurt base.

In typical formulation, the following ingredients are now added to the creamy yogurt base, however they can be added at any prior step in the formulation; natural and/or artificial flavor(s), color(s), seasoning(s), regular or dehydrated fruit and/or vegetable pieces, sweetener(s), emulsifier(s), thickening agent(s), starches, stabilizer(s), gum(s), powdered or hydrated milks and/or cream(s), antioxidant(s), probiotics(s), fiber, protein, oil(s), and/or preservative(s). The plain or flavored creamy yogurt base can then be consumed as is, or used as an ingredient in desserts, cooking, baking, and frozen systems to produce products that have similar appearance, texture and taste to products produced using full fat ingredients ranging from but not limited to cookies, cakes, pies, creams, brownies, pancakes, frozen yogurt, rolls, breads, muffins, and cheesecakes. The creamy yogurt base described in the present invention is free from chalkiness and graininess which are characteristics which typically accompany the use of gums at these levels. Based on this unexpected result of the combination of these known ingredients, the product being described falls into the general category of “composition of matter.” Overall, this innovative creamy yogurt base enables individuals to consume products with lower calories, fats, and cholesterol than traditional versions available on the market without sacrificing palatability and enjoyment.

### NON-PATENT CITATIONS

### Reference

1 Ogden C L, Carroll M D, Kit B K, Flegal K M. Prevalence of childhood and adult obesity in the United States, 2011-2012. Journal of the American Medical Association 2014; 311(8):806-814.
2 “Cheese and Related Cheese Products.” 21 CFR 133.133. 2013.
3 “Milk and Cream.” 21 CFR 131.160. 2013.
4 Ha E, Zemel M B. “Functional properties of whey, whey components, and essential amino acids: mechanisms underlying health benefits for active people.” Journal of Nutritional Biochemistry 2003; 14(5): 251-58.
5 Marshall, Keri. “Therapeutic application of whey protein.” Alternative Medicine Review 2004; 9(2): 136-56.

### Patents Referenced

| | Cited | | Publication | | |
|---|---|---|---|---|---|
| | Patent | Filing Date | Date | Applicant | Title |
| 6 | U.S. Pat. No. 4,968,512 | Dec. 20, 1989 | Nov. 6, 1990 | Kharrazi N | Method of making a yogurt spread |
| | | | | Michael | |
| 7 | U.S. Pat. No. 7,258,886 | Mar. 18, 2005 | Aug. 21, 2007 | Franklin Foods, | Yogurt Cream Cheese |
| | | | | Inc | |
| 8 | U.S. Pat. No. 4,434,184 | Dec. 13, 1982 | Feb. 28, 1984 | Kharrazi N | Yogurt spread resembling cream |
| | | | | Michael | cheese |

The embodiments of the invention in which an exclusive property or privilege is claimed are defined as follows:

1. The method of making a creamy yogurt base that provides similar appearance, texture, and taste to cream cheese and sour cream products, but it contains substantially less calories, fat, and cholesterol while providing a similar mouth feel associated with consuming the previously listed full fat products comprising the sequential steps of:
mixing a quantity of dairy liquid with a quantity of food grade gum;
combining the dairy liquid and gum mixture with an additional quantity of dairy liquid;
heating this diary liquid and gum mixture to a temperature between 85 degrees Fahrenheit and 250 degrees Fahrenheit, inclusive, for duration of 10-90 minutes;
mixing the heated dairy liquid and gum mixture with a quantity of Greek style yogurt;
cooling the resulting product to 45 degrees Fahrenheit or less to produce a creamy yogurt base.

2. The product defined in claim 1, said dairy liquid selected from the group consisting of milk with a milk fat content between 0.0-3.5%, cream, reconstituted milk with a milk fat content between 0.0-3.5%, and mixtures thereof.

3. The product defined in claim 1, said food grade gum selected from the group consisting of guar gum, carrageenan, locust bean gum, Xanthan gum, and mixtures thereof.

4. The product defined in claim 1, wherein the resulting product is whipped.

5. The product defined in claim 1, wherein additional ingredients are added during the preparation of or after the creamy yogurt base has been combined.

6. The product defined in claim 5, said additional ingredients selected from the group consisting of natural and/or artificial flavor(s), color(s), seasoning(s), regular or dehydrated fruit and/or vegetable pieces, sweetener(s), emulsifier(s), thickening agent(s), starches, stabilizer(s), gum(s), powdered or hydrated milks and/or cream(s), antioxidant(s), probiotics(s), fiber, protein, oil(s), preservative(s), and mixtures thereof.

7. The product defined in claim 5, wherein said product is used as a base or an ingredient to form dips, spreads, fillings, gravies, dressings, frostings, and desserts.

8. The product defined in claim 5, wherein said product is used in cooking, baking, or frozen systems to replace fats, therefore creating finished products of these previously mentioned systems that contain substantially less calories, fat, and cholesterol while providing similar texture, taste, and appearance to the original full fat product.

9. The product defined in claim 8, said fats selected from the group consisting of real and imitation butter, cream cheese, oil, shortenings, hydrogenated oils, sour cream, cream, mayonnaise, and mixtures thereof.
